(19) United States
(12) Patent Application Publication
(10) Pub. No.: US 2017/0272477 A1
(43) Pub. Date: Sep. 21, 2017

(54) CONFERENCE SYSTEM, CONNECTION CONTROL DEVICE AND CONNECTION CONTROL METHOD

(71) Applicant: Yuka KONNO, Kanagawa (JP)

(72) Inventor: Yuka KONNO, Kanagawa (JP)

(73) Assignee: Ricoh Company, Ltd., Tokyo (JP)

(21) Appl. No.: 15/434,181

(22) Filed: Feb. 16, 2017

(30) Foreign Application Priority Data
Mar. 17, 2016 (JP) 2016-053475

(51) Int. Cl. H04L 29/06

(52) U.S. Cl. CPC H04L 65/403; H04L 65/4015; H04L 65/1069; H04W 4/008

(57) ABSTRACT

A conference system includes a conference server device and a connection control device that are connected with each other via a closed network, the conference server device includes a storage that stores external terminal specifying information containing specifying information from a network other than the closed network, which specifies an external terminal being permitted to connect to the conference server device, and the connection control device includes circuitry configured to transmit control information for connection to the closed network to an internal terminal being connectable to the closed network; determine, when a request for connection to the conference server device is issued from the external terminal, whether the specifying information is contained in the external terminal specifying information; control communications between the internal terminal and the conference server device according to the control information; and permit the communications when the specifying information is contained in the external terminal specifying information.

### CROSS-REFERENCE TO RELATED APPLICATIONS

The present application claims priority under 35 U.S.C. §119 to Japanese Patent Application No. 2016-053475, filed Mar. 17, 2016. The contents of which are incorporated herein by reference in their entirety.

### BACKGROUND OF THE INVENTION

1. Field of the Invention

The embodiments discussed herein are directed to a conference system, a connection control device and a connection control method.

2. Description of the Related Art

A conference system that controls connections of terminals used by users to a network to implement a network conference has been known conventionally. Japanese Unexamined Patent Application Publication No. 2006-121412 discloses an invention of an authentication system that ensures the security in a closed network.

There is a network conference that permits only terminals that are connected to a closed network to access, for example, a document used in the network conference in consideration of security against leakage of the document to the outside. In the network conference, a user is able to connect to the closed network to participate in the conference by holding a terminal against a connection control device employing, for example, near field communication (NFC) and only terminals that succeed in connecting to the closed network are able to access, for example, the document. In the current circumstances where network conferences are frequently carried out among users distant from one another, a user who is in a distant place is unable to hold the terminal against the connection control device and thus is unable to join the network conference.

In view of the above-described circumstances, there is a need to provide a conference system, a connection control device and a connection control method that allow a user who is not on the side of the connection control device to participate in the network conference while maintaining the security of the network.

### SUMMARY OF THE INVENTION

According to exemplary embodiments of the present invention, there is provided a conference system comprising a conference server device and a connection control device that are connected with each other via a closed network usable in a limited area, wherein the conference server device comprises: a storage unit that stores external terminal specifying information containing specifying information from a network other than the closed network, which is specifying information specifying an external terminal that is permitted to connect to the conference server device, and the connection control device includes circuitry configured to transmit control information for connection to the closed network to an internal terminal within a distance in which the internal terminal is connectable to the closed network; determine, when a request for connection to the conference server device is issued from the external terminal, whether the specifying information that specifies the external terminal having transmitted the request is contained in the external terminal specifying information; control communications between the internal terminal and the conference server device according to the control information; and permit communications between the external terminal and the conference server device when it is determined that the specifying information that specifies the external terminal is contained in the external terminal specifying information.

Exemplary embodiments of the present invention also provide a connection control device that is connected to a conference server device via a closed network usable in a limited area, the connection control device comprising: circuitry configured to transmit control information for connection to the closed network to an internal terminal within a distance in which the internal terminal is connectable to the closed network; determine, when a request to connect to the conference server device is issued from an external device via a network other than the closed network, whether specifying information that specifies the external terminal having transmitted the request is contained in external terminal specifying information that contains specifying information from the network other than the closed network, which is specifying information specifying the external terminal that is permitted to connect to the conference server device; control communications between the internal terminal and the conference server device according to the control information; and permit communications between the external terminal and the conference server device when it is determined that the specifying information that specifies the external terminal is contained in the external terminal specifying information.

Exemplary embodiments of the present invention also provide a connection control method performed by a conference system including a conference server device and a connection control device that are connected with each other via a closed network usable in a limited area, the conference server device including a storage unit that stores external terminal specifying information containing specifying information from a network other than the closed network, which is specifying information specifying an external terminal that is permitted to connect to the conference server device, the connection control method comprising: by the connection control device, transmitting control information for connection to the closed network to an internal terminal within a distance in which the internal terminal is connectable to the closed network; by the connection control device, when a request for connection to the conference server device is issued from the external terminal via the network other than the closed network, determining whether the specifying information that specifies the external terminal having transmitted the request is contained in the external terminal specifying information; by the connection control device, controlling communications between the internal terminal and the conference server device according to the control information; and by the connection control device, permitting communications between the external terminal and the conference server device when it is determined that the specifying information that specifies the external terminal is contained in the external terminal specifying information.

### BRIEF DESCRIPTION OF THE DRAWINGS

FIG. 1 is a diagram of an exemplary device configuration of a conference system according to an embodiment;

FIG. 2 is a diagram of an exemplary functional configuration of a conference server device according to the embodiment;

FIG. 3 is a diagram of an exemplary conference specifying information and exemplary participant information according to the embodiment;

FIG. 4 is a diagram of an exemplary functional configuration of a connection control device according to the embodiment;

FIG. 5 is a diagram of an exemplary functional configuration of a terminal according to the embodiment;

FIG. 6 is a flowchart of an exemplary connection control method performed by a connection control device according to the embodiment;

FIG. 7 is a diagram of exemplary initial screen information that is displayed on an internal terminal according to the embodiment;

FIG. 8 is a diagram of exemplary initial screen information that is displayed on an external terminal according to the embodiment;

FIG. 9 is a sequence chart of an exemplary connection control method (in the case of the external terminal) according to the embodiment;

FIG. 10 is a diagram of exemplary mode screen information (before a conference) according to the embodiment;

FIG. 11 is a diagram of exemplary mode screen information (after the conference) according to the embodiment;

FIG. 12 is a diagram of Example 1 of conference screen information according to the embodiment;

FIG. 13 is a diagram of Example 2 of the conference screen information according to the embodiment;

FIG. 14 is a diagram of Example 3 of the conference screen information according to the embodiment;

FIG. 15 is a diagram of an exemplary hardware configuration of a conference server device according to the embodiment;

FIG. 16 is a diagram of an exemplary hardware configuration of the connection control device according to the embodiment; and

FIG. 17 is a diagram of an exemplary hardware configuration of the terminal according to the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION ACCORDING TO THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of a conference system, a connection control device, and a connection control method will be described in detail below with reference to the accompanying drawings.

Device Configurations of Conference System

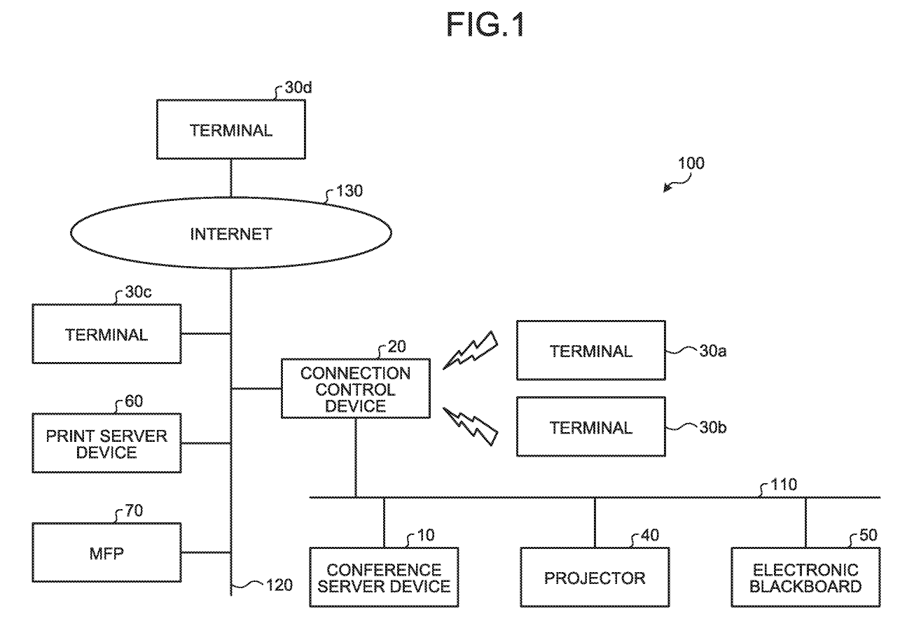

FIG. 1 is a diagram of an exemplary device configuration of a conference system 100 according to an embodiment. The conference system 100 includes a conference server device 10, a connection control device 20, terminals 30a to 30d, a projector 40, an electronic blackboard 50, a print server device 60 and a multifunction peripheral (MFP) 70. The terminals 30a to 30d will be referred to simply as terminals 30 when they are not particularly distinguished. The number of the terminals 30 are not limited to 4, i.e., any number of the terminals 30 may be used.

The conference server device 10, the connection control device 20, the projector 40 and the electronic blackboard 50 are connected to one another via a first network 110. The terminals 30a and 30b are connectable to the first network via the connection control device 20.

The first network 110 is implemented by using a combination of wired connection and wireless connection. For example, the conference server device 10, the projector 40 and the electronic blackboard 50 have wired connections to the first network 110 and the terminal 30 has a wireless connection to the first network 110. The conference server device 10, the projector 40 and the electronic blackboard 50 may be wirelessly connected to the first network 110 and thus all the devices may be connected wirelessly with one another. The first network 110 is a closed network usable in a limited area. The first network 110 is, for example, a closed network usable in a specific room, such as a conference room.

The connection control device 20, the terminal 30c, the print server device 60 and the MFP 70 are connected with one another via a second network 120. The terminal 30d is connected to the second network 120 via the Internet 130.

The communication system of the second network 120 may be wired or wireless or may be implemented by using a combination of the wired system and the wireless system. The second network 120 is a network usable in, for example, an entire building.

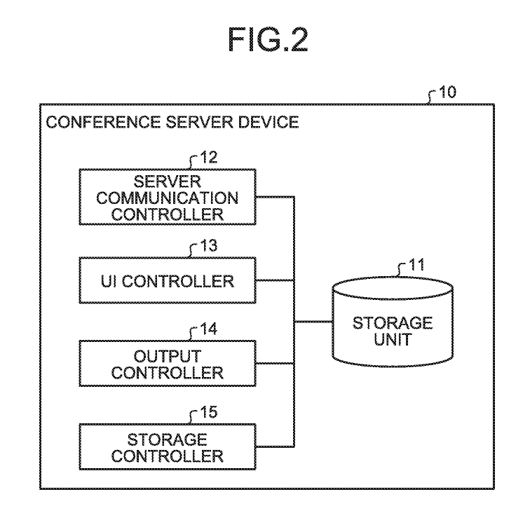

The conference server device 10 controls a network conference that is carried out by using the terminals 30, the projector 40 and the electronic blackboard 50. The conference server device 10 controls storage of, for example, conference document data, user interface (UI) information, external terminal specifying information, conference specifying information and participant information and controls transmission of, for example, the conference document data, the UI information, the external terminal specifying information. The conference document data, the UI information, the external terminal specifying information, the conference specifying information and the participant information will be described below. The functional configuration of the conference server device 10 will be described in detail below with reference to FIG. 2.

The connection control device 20 is a device having the first commination system and the second communication system. The first communication system is near-field wireless communication according to, for example, NFC or Bluetooth (trademark). The first communication system is, for example, used to transmit control information necessary for wireless connection to the first network 110. The control information necessary for wireless connection to the first network 110 is, for example, a service set identifier (SSID) and an encryption key (password).

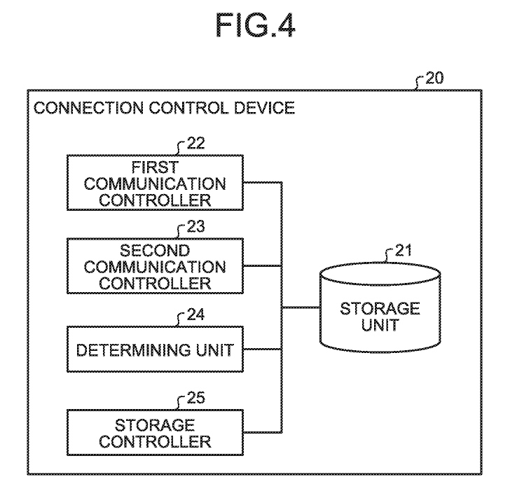

The second communication system is a wired LAN according to, for example, Ethernet (trademark) and a wireless LAN according to, for example, Wi-Fi (trademark). The second communication system is used for connection to the first network 110. The functional configuration of the connection control device 20 will be described with reference to FIG. 4.

The terminals 30 are devices that are used by users in the network conference. The terminal 30 is, for example, a smart device or a laptop PC.

The projector 40 is a device that projects data that is referred to by the users in the network conference. The electronic blackboard 50 is a device that is able to display data that is stored in the conference server device 10 and on which it is possible to add data to the data with an electronic pen. The print server device 60 is a device that receives print requests from multiple devices and controls, for example, the sequence of processes based on the print request. The MFP 70 is a device having multiple functions, such as a copy function, a print function, a scanner function and a FAX function.

The terminals 30 that are connected to the first network 110 will be referred to as internal terminals. The terminals 30 that are connected to networks other than the first network 110 will be referred to as an external terminal. In the example illustrated in FIG. 1, the terminal 30a and the terminal 30b are internal terminals. In the example illustrated in FIG. 1, the networks other than the first network 110 are the second network 120 and the Internet 130 and the terminals 30c and 30d are external terminals.

Functional Configuration of Conference Server Device

An exemplary functional configuration of the conference server device 10 according to the embodiment will be described here.

FIG. 2 is a diagram of the exemplary functional configuration of the conference server device 10 according to the embodiment. The conference server device 10 includes a storage unit 11, a server communication controller 12, a UI controller 13, an output controller 14 and a storage controller 15.

The storage unit 11 stores information. The information stored in the storage unit 11 is, for example, the conference document data, the UI information, the external terminal specifying information, the conference identifying information and the participant information.

The conference document data is, for example, data that is displayed on the terminals 30, the projector 40 and the electronic blackboard 50. The UI information is, for example, screen information that is displayed on the terminal 30.

The external terminal specifying information contains specifying information that specifies external terminals that are permitted to connect to the conference server device 10 among the external terminals that are connected to the network other than the first network 110. The specifying information is, for example, a MAC address and an IP address.

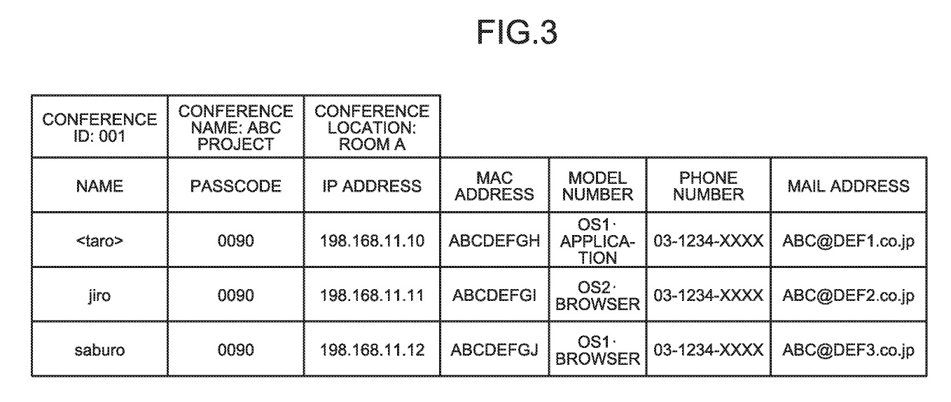

The conference specifying information is information that specifies the conference. The participant information is information on participants in the conference. FIG. 3 represents exemplary conference specifying information and exemplary participant information.

The conference specifying information according to the embodiment contains a conference ID, a conference name and a conference location. The conference ID is identifying information that identifies the conference. The conference name is the name of the conference. The conference location represents the location at which the conference is carried out. FIG. 3 exemplifies the case where “001” is set for the conference ID, “ABC PROJECT” is set for the conference name and “ROOM A” is set for the conference location.

The participant information according to the embodiment contains names, passcodes, IP addresses, MAC addresses, model numbers, phone numbers and mail addresses. The participant information is stored for each conference. The participant information according to FIG. 3 is information on participants in the conference that is identified by the conference ID “001”.

The name is, for example, the name, a user name or a nickname of a participant. The name with < > represents the organizer of the conference. The passcode is information that is input to participate in the conference. The passcode is, for example, four-digit alphanumeric character. The passcode is set for each conference. The IP address is the IP address of the terminal 30 that is used by a participant. The IP address of the terminal 30 may be assigned by using a fixed IP address or may be assigned actively by the DHCP server. The MAC address is the MAC address of the terminal 30 that is used by the participant. The MAC address of the terminal 30 is unique hardware information of the terminal 30. The model number is information that specifies the type of a client program that runs on the terminal 30. The model number is, for example, a combination of the OS name, the application name, the browser name and the version. The model number is, for example, referred to by the conference server device 10 in order to transmit appropriate screen information to the terminal 30. The phone number is the phone number of the participant. The mail address is the mail address of the participant.

According to the example represented in FIG. 3, the participants in the conference identified by the conference ID “001” are taro, jiro and saburo. The organizer of the conference identified by the conference ID “001” is taro to which < > is added, and the passcode of the conference is “0090”.

The server communication controller 12 controls communications of data that is displayed in the conference. The server communication controller 12 inputs data that is received via the first network 110 to the UI controller 13, the output controller 14 and the storage controller 15. On receiving data to be transmitted from the UI controller 13, the output controller 14 and the storage controller 15, the server communication controller 12 transmits the data to another device via the first network 110.

The UI controller 13 controls screen information that is displayed on the terminal 30. For example, the UI controller 13 transmits initial screen information (see FIG. 8) in response to a connection request that is received from an external terminal (the terminal 30c or the terminal 30d) to the terminal 30 via the connection control device 20.

The output controller 14 controls output of the conference document data. The output controller 14 chooses a destination to which the conference document data is to be output from the terminals 30, the projector 40 and the electronic blackboard 50 and outputs the conference document data to the chosen output destination via the server communication controller 12.

The storage controller 15 performs storage control, such as reading, adding, deleting and changing, on information that is stored in the storage unit 11. On receiving the specifying information of a terminal 30 to be added to the external terminal specifying information from the terminal 30, the storage controller 15 adds the specifying information to the external terminal specifying information in the storage unit 11. When the above-described external terminal specifying information is updated, the storage controller 15 transmits the external terminal specifying information to the connection control device 20 via the server communication controller 12.

Functional Configuration of Connection Control Device

An exemplary functional configuration of the connection control device 20 according to the embodiment will be described here.

FIG. 4 is a diagram of an exemplary functional configuration of the connection control device 20 of the embodiment. The connection control device 20 of the embodiment includes a storage unit 21, a first communication controller 22, a second communication controller 23, a determining unit 24 and a storage controller 25.

The storage unit 21 stores information. The storage unit 21 store, for example, the above-described external terminal specifying information. When there is an access to the conference server device 10 from an external terminal that is connected to a network other than the first network 110, the external terminal specifying information is read by the storage controller 25 from the storage unit 21 and referred to by the determining unit 24.

The first communication controller 22 transmits the above-described control information to connect to the first network 110 to the internal terminals within the communication area of the first communication system. For example, when the first communication system is NFC, the user of the internal terminal within a distance in which the internal terminal is connectable to the first network 110 is able to hold the internal terminal against the connection control device 20. Accordingly, the internal terminal is able to receive the control information from the connection control device 20. When the communications between the internal device and the conference server device 10 is implemented with a wireless LAN, the control information is an SSID and an encryption key.

The second communication controller 23 controls communications between devices that are connected to the first network 110 by using the above-described second communication system.

Specifically, on receiving communication data using the above-described control information from the internal terminal, the second communication controller 23 controls communications between the internal device (the terminal 30c or the terminal 30d) according to the second communication system.

When a connection request that is transmitted from the external device is permitted by the determining unit 24, the second communication controller 23 permits communications between the external terminal (the terminal 30c or the terminal 30d) and the conference server device 10.

The communications between the terminals 30 (the internal devices and the external devices) and the conference server device 10 that are performed according to the second communication system are transmission of the screen information from the conference server device 10 in response to a request for the screen information from the terminal 30, transmission of the conference document data from the conference server device 10 in response to a request for the conference document data from the terminal 30, and a request, from the terminal 30, to output the conference document data to the projector 40 or the electronic blackboard 50.

When a request for connection to the conference server device 10 is issued from the external terminal, the determining unit 24 determines whether the specifying information that specifies the external terminal having transmitted the connection request is contained in the above-described external terminal specifying information. When the specifying information that specifies the external terminal having transmitted the connection request is contained in the above-described external terminal specifying information, the determining unit 24 permits the request for connection to the conference server device 10 from the external terminal. When the specifying information that specifies the external terminal having transmitted the connection request is not contained in the above-described external terminal specifying information, the determining unit 24 does not permit the request for connection to the conference server device 10 from the external terminal.

The storage controller 25 performs storage control, such as reading, adding, deleting and changing, on the information that is stored in the storage unit 21. When, for example, the above-described external terminal specifying information that is stored in the conference server device 10 is updated, the storage controller 25 updates the external terminal specifying information in the storage unit 21 by using the external terminal specifying information that is transmitted from the conference server device 10 to the connection control device 20 by using the second communication system.

Functional Configuration of Terminal

An exemplary functional configuration of the terminal 30 according to the embodiment will be described here.

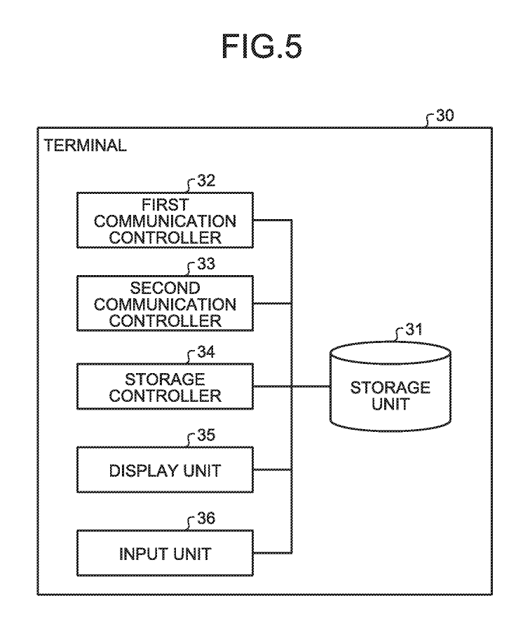

FIG. 5 is a diagram of an exemplary functional configuration of the terminal 30 according to the embodiment. The terminal 30 according to the embodiment includes a storage unit 31, a first communication controller 32, a second communication controller 33, a storage controller 34, a display unit 35 and an input unit 36.

The storage unit 31 stores information. The information that is stored in the storage unit 31 is, for example, information that is stored by the user of the terminal 30.

The first communication controller 32 receives the above-described control information to connect to the first network 110 from the connection control device 20 within the communication area of the first communication system described above.

The second communication controller 33 controls communications with the conference server device 10 by using the above-described second communication system.

The storage controller 34 controls storage control, such as reading, adding, deleting and changing, on the information that is stored in the storage unit 31.

The display unit 35 displays information. The information that is displayed on the display unit 35 is, for example, the conference document data or the screen information that is received from the conference server device 10 via the connection control device 20. The input unit 36 receives an input representing an operation of the user. The display unit 35 and the input unit 36 may be implemented by using, for example, a liquid crystal panel having a display function and an input function.

Connection Control Method

An exemplary connection control method performed by the connection control device 20 according to the embodiment will be described here.

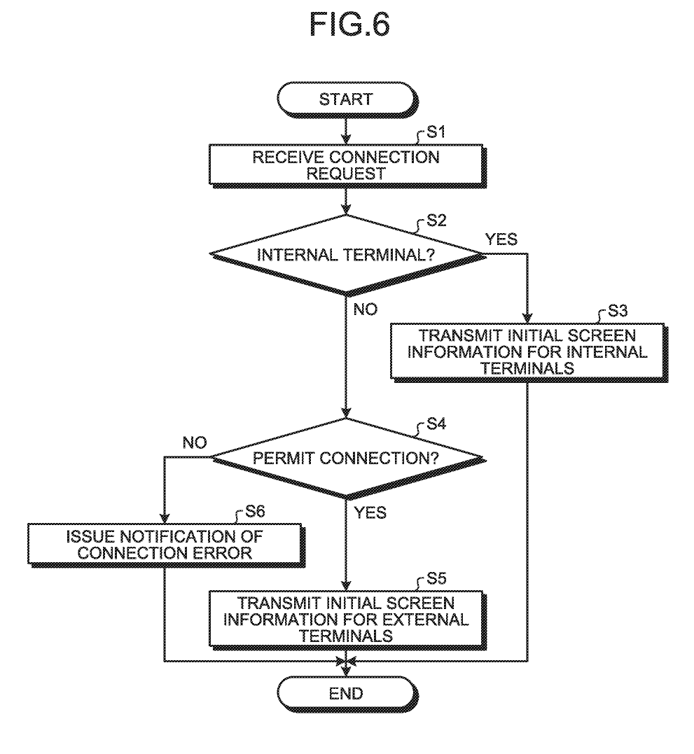

FIG. 6 is a flowchart of the exemplary connection control method performed by the connection control device 20 according to the embodiment. First of all, the second communication controller 23 receives a request for connection to the conference server device 10 from the terminal 30 (step S1). The second communication controller 23 that determines whether the terminal 30 from which the connection request is transmitted is the internal device (the terminal 30a or the terminal 30b) based on the IP address, etc., of the terminal 30 that is contained in the connection request (step S2).

When the terminal 30 from which the connection request is transmitted is the internal terminal (the terminal 30a or the terminal 30b) (YES at step S2), the second communication controller 23 transmits, as a response to the connection request, the initial screen information for the internal terminals to the terminal 30 (step S3).

Specifically, the second communication controller 23 transmits the connection request that is received in the process at step S1 to the conference server device 10 and transmits the initial screen information for the internal terminals that is transmitted from the conference server device 10 to the terminal 30.

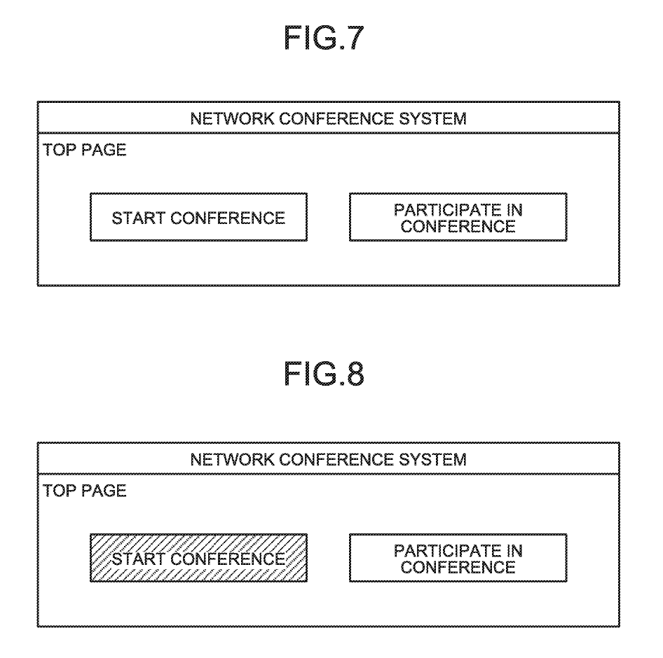

FIG. 7 is a diagram of exemplary initial screen information that is displayed on the internal terminals (the terminal 30a and the terminal 30b). The initial screen information contains a “start the conference” button and a “participate in the conference” button. The “start the conference” button is pushed by the organizer of a conference when starting the conference. The “participate in the conference” button is pushed by a participant in a conference to participate in the conference.

FIG. 6 will be referred back here. When the terminal 30 from which the connection request is transmitted is not the internal terminal (the terminal 30a or the terminal 30b) (NO at step S2), the determining unit 24 determines whether to permit connection of the external terminal (the terminal 30c or the terminal 30d) (step S4). Specifically, the determination unit 24 determines whether the specifying information (such as the MAC address) of the terminal 30 contained in the connection request received by the terminal 30 in the process at step S1 is contained in the above-described external terminal specifying information.

When the connection is permitted (YES at step s4), the second communication controller 23 transmits initial screen information for the external terminals as a response to the connection request (step S5). Specifically, the second communication controller 23 transmits the connection request received in the process at step S1 to the conference server device 10 and transmits the initial screen information for the external terminals that is transmitted from the conference server device 10 to the terminal 30.

FIG. 8 is a diagram of exemplary initial screen information that is displayed on the external devices (the terminal 30a and the terminal 30b) according to the embodiment. The initial screen information contains the “start the conference” button and the “participate in the conference” button. Descriptions of the “start the conference” button and the “participate in the conference” button will be omitted as they are the same as those of FIG. 7. The users of the external devices (the terminal 30c and the terminal 30d) cannot be organizers of the conference and thus it is not possible to push the “start the conference” button on the exemplary initial screen information represented in FIG. 8.

FIG. 6 will be referred back here. When the connection is not permitted (NO at step S4), the second communication controller 23 transmits a connection error notification indicating that connection to the conference server device 10 is not permitted as a response to the connection request to the terminal 30 (step S5).

An exemplary connection control method performed by the external terminals (the terminal 30a and the terminal 30b) according to the embodiment will be described here.

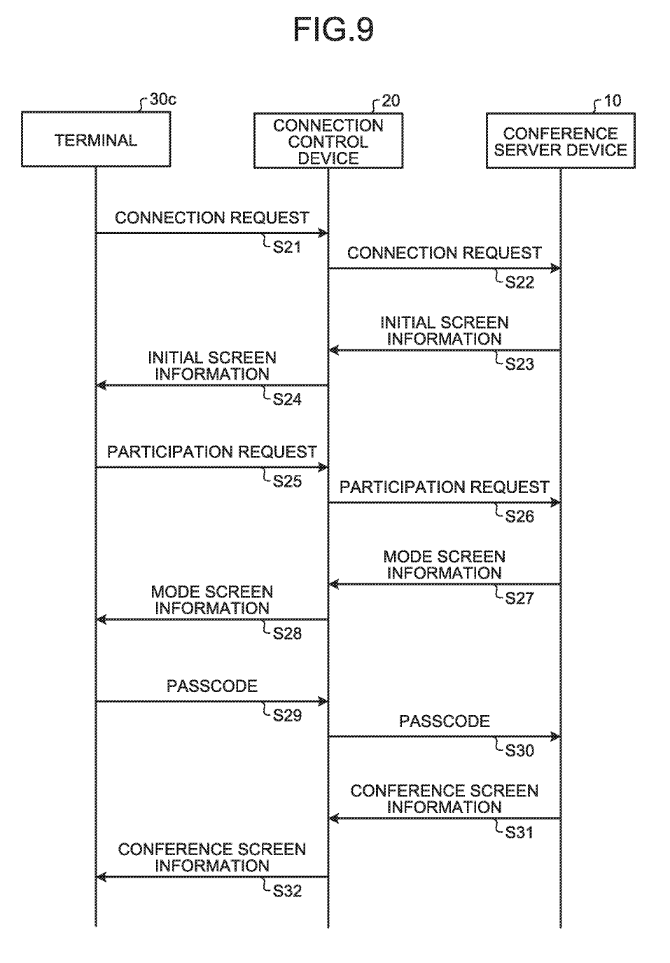

FIG. 9 is a sequence chart of an exemplary connection control method (in the case of the external terminal) according to the embodiment. FIG. 9 exemplifies the case where the external terminal is the terminal 30c. The same connection control method is performed when the external terminal is the terminal 30d.

First of all, the second communication controller 33 of the terminal 30c transmits a request for connection to the conference server device 10 to the connection control device 20 (step S21). For example, by accessing the uniform resource locator (URL) that specifies the connection control device 20, the second communication controller 33 transmits the request for connection to the conference server device 10 to the connection control device 20.

When the second communication controller 23 of the connection control device 20 permits connection of the terminal 30c, the second communication controller 23 transmits the connection request that is transmitted in the process at step S1 to the conference server device 10 (step S22). Specifically, the second communication controller 23 acquires the specifying information (such as the MAC address) of the terminal 30c contained in the connection request that is transmitted from the terminal 30c in the process at step S21 and inputs the specifying information in the determining unit 24. When the determining unit 24 determines that the specifying information is contained in the external terminal specifying information, the second communication controller 23 transmits the connection request that is transmitted in the process at step S21 to the conference server device 10.

On receiving the connection request from the connection control device 20, the server communication controller 12 of the conference server device 10 then transmits the initial screen information to the connection control device 20 (step S23).

On receiving the initial screen information from the conference server device 10, the second communication controller 23 of the connection control device 20 transmits the initial screen information to the terminal 30c (step S24). When the input unit 36 of the terminal 30c receives pushing of the “start the conference” button that is contained in the initial screen information, the second communication controller 33 of the terminal 30c transmits a participation request to the connection control device 20 (step S25).

On receiving the participation request from the terminal 30c, the second communication controller 23 of the connection control device 20 transmits the participation request to the conference server device 10 (step S26). On receiving the participation request from the connection control device 20, the server communication controller 12 of the conference server device 10 transmits mode screen information to the connection control device 20 (step S27).

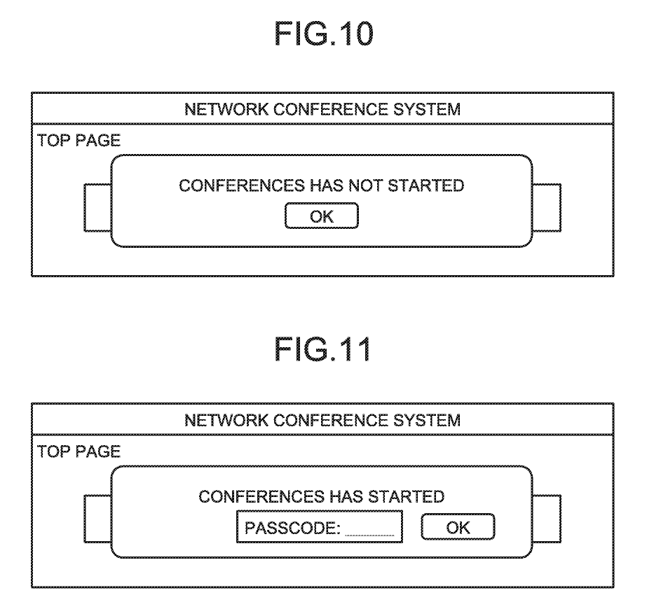

FIG. 10 is a diagram of exemplary mode screen information (before the conference) according to the embodiment. FIG. 10 exemplifies the mode screen information on which a participant in the conference pushes the “participate in the conference” button in a mode where the “start the conference” button is not pushed yet by the organizer of the conference.

FIG. 11 is a diagram of exemplary mode screen information (after the conference) according to the embodiment. FIG. 11 exemplifies the mode screen information on which a participant in the conference pushes the “participate in the conference” button in the mode where the “start the conference” button is pushed by the organizer of the conference. The mode screen information that is displayed after the conference is started contains an entry field for a passcode to participate in the conference. When a participant in the conference is not required to enter a passcode, it is unnecessary to display the passcode entry field. The case where a participant in the conference is not required to enter a passcode is the case where a passcode to participate in the conference is not set in the above-described participant information (see FIG. 3).

FIG. 9 will be referred back here. On receiving the mode screen information from the conference server device 10, the second communication controller 23 of the connection control device 20 transmits the mode screen information to the terminal 30c (step S28). When the input unit 36 of the terminal 30c receives an input of a passcode via the mode screen information, the second communication controller 33 of the terminal 30c transmits the passcode to the connection control device 20 (step S29). On receiving the passcode from the terminal 30c, the second communication controller 23 of the connection control device 20 transmits the passcode to the conference server device 10 (step S30).

When the server communication controller 12 of the conference server device 10 receives the passcode from the connection control device 20 and the passcode transmitted from the terminal 30c matches the passcode that is set in the participant information (see FIG. 3), the server communication controller 12 transmits conference screen information to the connection control device 20 (step S31). On receiving the conference screen information from the conference server device 10, the second communication controller 23 of the connection control device 20 transmits the conference screen information to the terminal 30c (step S32).

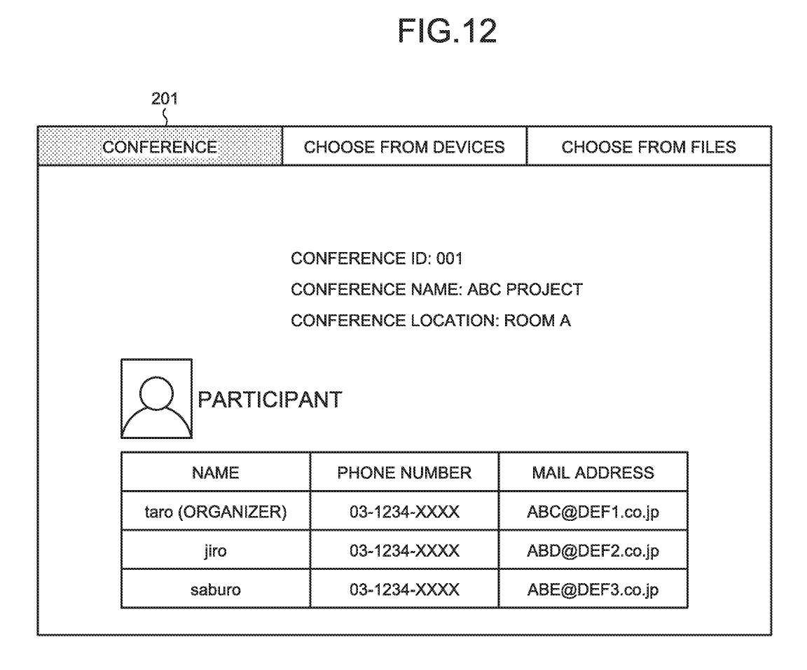

FIG. 12 is a diagram of Example 1 of the conference screen information according to the embodiment. FIG. 12 exemplifies the conference screen information in the case where a “conference” tab 201 is chosen. FIG. 12 exemplifies the case where the above-described conference specifying information and the names, the phone numbers, and the mail addresses contained in the participant information (see FIG. 3) are displayed.

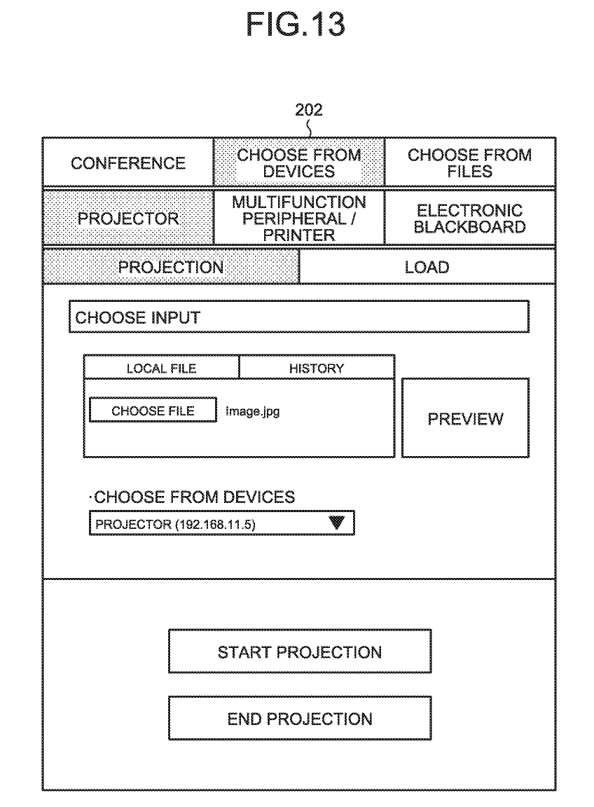

FIG. 13 is a diagram of Example 2 of the conference screen information according to the embodiment. FIG. 13 exemplifies the conference screen information in the case where “choose from devices” tab 202 is chosen. The conference screen information exemplified in FIG. 13 is displayed in the case where the conference document information is projected on the projector 40.

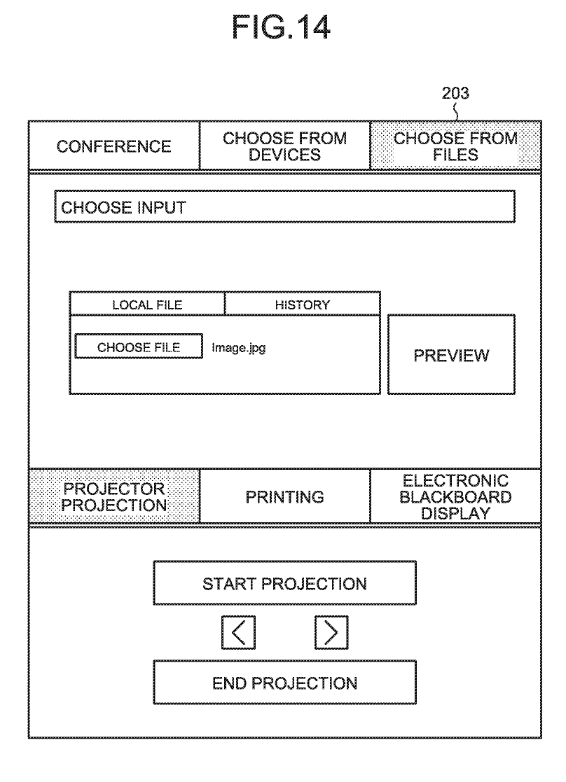

FIG. 14 is a diagram of Example 3 of the conference screen information according to the embodiment. FIG. 14 exemplifies the conference screen information in the case where a “choose from files” tab 203 is chosen. The conference screen information exemplified in FIG. 14 is displayed in the case where, for example, the conference document data is projected to the projector 40.

Hardware Configuration

An exemplary hardware configuration of the conference server device 10, the connection control device 20 and the terminal 30 will be described lastly.

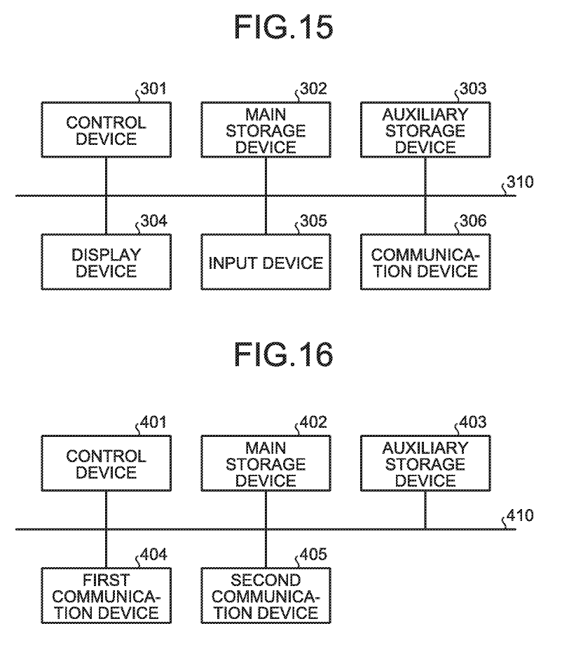

FIG. 15 is a diagram of an exemplary hardware configuration of the conference server device 10 according to the embodiment. The conference server device 10 of the embodiment includes a control device 301, a main storage device 302, an auxiliary storage device 303, a display device 304, an input device 305 and a communication device 306. The control device 301, the main storage device 302, the auxiliary storage device 303, the display device 304, the input device 305 and the communication device 306 are connected with one another via a bus 310.

The control device 301 executes a program that is read from the auxiliary storage device 303 into the main storage device 302. The main storage device 302 is a memory, such as a ROM or a RAM. The auxiliary storage device 303 is, for example, a memory card or a solid state drive (SSD).

The display device 304 displays information. The display device 304 is, for example, a liquid crystal display. The input device 305 receives an input of information. The input device 305 may be, for example, a keyboard and a mouse. The display device 304 and the input device 305 may be, for example, a liquid crystal touch panel having both a display function and an input function. The communication device 306 communicates with other devices.

The conference server device 10 does not necessarily include the display device 304 and the input device 305. In other words, a setting for the conference server device 10, etc., may be received from another device via the communication device 306.

FIG. 16 is a diagram of an exemplary hardware configuration of the connection control device 20 according to the embodiment. The connection control device 20 according to the embodiment includes a control device 401, a main storage device 402, an auxiliary storage device 403, a first communication device 404 and a second communication device 405. The control device 401, the main storage device 402, the auxiliary storage device 403, the first communication device 404 and the second communication device 405 are connected with one another via a bus 410.

Descriptions of the control device 401, the main storage device 402 and the auxiliary storage device 403 are the same as those of the control device 301, the main storage device 302 and the auxiliary storage device 303 (see FIG. 15), and thus they will be omitted.

The first communication device 404 is a device that performs near-filed wireless communications according to, for example, NFC or Bluetooth (trademark). The second communication device 405 is a device that performs wireless communications according to, for example, Wi-Fi (trademark).

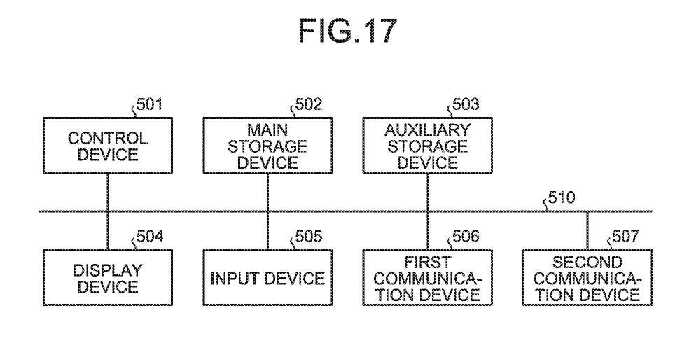

FIG. 17 is a diagram of an exemplary hardware configuration of the terminal 30 according to the embodiment. The terminal 30 according to the embodiment includes a control device 501, a main storage device 502, an auxiliary storage device 503, a display device 504, an input device 505, a first communication device 506 and a second communication device 507. The control device 501, the main storage device 502, the auxiliary storage device 503, the display device 504, the input device 505, the first communication device 506 and the second communication device 507 are connected with one another via a bus 510.

Descriptions of the control device 501, the main storage device 502, the auxiliary storage device 503, the display device 504 and the input device 505 will be omitted as they are the same as those of the control device 301, the main storage device 302, the auxiliary storage device 303, the display device 304 and the input device 305 (see FIG. 15). Furthermore, descriptions of the first communication device 506 and the second communication device 507 will be omitted as they are the same as those of the first communication device 404 and the second communication device 405 (see FIG. 15).

The program that is executed by the conference server device 10, the connection control device 20 and the terminal 30 is stored in a computer-readable recording medium, such as a CD-ROM, a memory card, a CD-R or a digital versatile disk (DVD), in a file in an installable or executable form and is provided as a computer program product.

The program that is executed by the conference server device 10, the connection control device 20 and the terminal 30 may be configured to be stored in a computer connected to a network, such as the Internet, and to be downloaded via the network to be provided. The program that is executed by the conference server device 10, the connection control device 20 and the terminal 30 may be configured to be provided via a network, such as the Internet, without being downloaded.

The program that is executed by the conference server device 10, the connection control device 20 and the terminal 30 may be configured to be incorporated in, for example, a ROM in advance to be provided.

The program that is executed by the conference server device 10, the connection control device 20 and the terminal 30 has a module configuration containing functions that are implemented by the program among the functional configurations of the conference server device 10, the connection control device 20 and the terminal 30 according to the embodiment.

The control device 301 (401 or 501) reads the program from a storage medium, such as the auxiliary storage device 303 (403 or 503), and executes the program and accordingly the functions implemented by the program are loaded into the main storage device 302 (402 or 502). In other words, the functions implemented by the program are generated in the main storage device 302 (402 or 502).

Part of or all the functions of the conference server device 10, the connection control device 20 and the terminal 30 according to the embodiment may be implemented by using hardware, such as an integrated circuit (IC).

As described above, in the conference system 100 according to the embodiment, the storage unit 11 of the conference server device 10 stores the external terminal specifying information that contains the specifying information from a network other than the first network 110 (closed network) usable in the limited area, which is the specifying information specifying the external terminals (the terminal 30c and the terminal 30d) that are permitted to connect to the conference server device 10. The first communication controller 22 of the connection control device 20 transmits the control information for connection to the first network 110 to the internal terminals (the terminal 30a and the terminal 30b) within a distance in which the internal terminals are able to connect to the closed network. When a request for connection to the conference server device 10 is issued from the external terminal, the determining unit 24 of the connection control device 20 determines whether the specifying information that specifies the external terminal having transmitted the connection request is contained in the external terminal specifying information. Furthermore, the second communication controller 23 of the connection control device 20 controls communications between the internal terminals and the conference server device 10 according to the control information and permits communications between the external terminal and the conference server device 10 when it is determined that the specifying information that specifies the external terminal is contained in the external terminal specifying information.

Thus, according to the conference system 100 of the embodiment, it is possible to maintain the security of the conference even when a user who uses the terminal 30 not on the side of the connection control device 20 is allowed to participate in a conference in which users who uses the terminals 30 on the side of the connection control device 20 participate.

The users of the external terminals (the terminal 30c and the terminal 30d) are able to use the network conference that is controlled by the conference server device 10 without performing an operation foe re-connection to the first network 110.

According to the embodiment, there is an effect that it is possible to allow a user who is not on the side of the connection control device to participate in a network conference while maintaining the security of the network conference.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A conference system comprising a conference server device and a connection control device that are connected with each other via a closed network usable in a limited area,
wherein
the conference server device comprises:
a storage unit that stores external terminal specifying information containing specifying information from a network other than the closed network, which is specifying information specifying an external terminal that is permitted to connect to the conference server device, and
the connection control device includes circuitry configured to
transmit control information for connection to the closed network to an internal terminal within a distance in which the internal terminal is connectable to the closed network;
determine, when a request for connection to the conference server device is issued from the external terminal, whether the specifying information that specifies the external terminal having transmitted the request is contained in the external terminal specifying information;
control communications between the internal terminal and the conference server device according to the control information; and
permit communications between the external terminal and the conference server device when it is determined that the specifying information that specifies the external terminal is contained in the external terminal specifying information.

2. The conference system according to claim 1, wherein a communication system of the first communication controller is near field communication (NFC).

3. The conference system according to claim 1, wherein
a communication system between the internal terminal and the conference server device is a wireless LAN, and
the control information is a service set identifier (SSID) and an encryption key.

4. A connection control device that is connected to a conference server device via a closed network usable in a limited area, the connection control device comprising:
circuitry configured to
transmit control information for connection to the closed network to an internal terminal within a distance in which the internal terminal is connectable to the closed network;
determine, when a request to connect to the conference server device is issued from an external device via a network other than the closed network, whether specifying information that specifies the external terminal having transmitted the request is contained in external terminal specifying information that contains specifying information from the network other than the closed network, which is specifying information specifying the external terminal that is permitted to connect to the conference server device;
control communications between the internal terminal and the conference server device according to the control information; and
permit communications between the external terminal and the conference server device when it is determined that the specifying information that specifies the external terminal is contained in the external terminal specifying information.

5. The connection control device according to claim 4, wherein a communication system for performing the transmitting is near field communication (NFC).

6. The connection control device according to claim 4, wherein
a communication system between the internal terminal and the conference server device is a wireless LAN, and
the control information is a service set identifier (SSID) and an encryption key.

7. A connection control method performed by a conference system including a conference server device and a connection control device that are connected with each other via a closed network usable in a limited area, the conference server device including a storage unit that stores external terminal specifying information containing specifying information from a network other than the closed network, which is specifying information specifying an external terminal that is permitted to connect to the conference server device, the connection control method comprising:
by the connection control device, transmitting control information for connection to the closed network to an internal terminal within a distance in which the internal terminal is connectable to the closed network;
by the connection control device, when a request for connection to the conference server device is issued from the external terminal via the network other than the closed network, determining whether the specifying information that specifies the external terminal having transmitted the request is contained in the external terminal specifying information;
by the connection control device, controlling communications between the internal terminal and the conference server device according to the control information; and
by the connection control device, permitting communications between the external terminal and the conference server device when it is determined that the specifying information that specifies the external terminal is contained in the external terminal specifying information.

8. The connection control method according to claim 7, wherein a communication system for performing the transmitting is near field communication (NFC).

9. The connection control method according to claim 7, wherein
a communication system between the internal terminal and the conference server device is a wireless LAN, and the control information is a service set identifier (SSID) and an encryption key.
